(19) United States
(12) Patent Application Publication
(10) Pub. No.: US 2010/0201918 A1
(43) Pub. Date: Aug. 12, 2010

(54) LIQUID CRYSTAL DISPLAY APPARATUS AND LIQUID CRYSTAL DISPLAY PANEL THEREOF

(75) Inventors: Chih-Yung Hsieh, Tainan County (TW); Chien-Hong Chen, Tainan County (TW); Ying-Jen Chen, Tainan County (TW)

Correspondence Address: LOWE HAUPTMAN HAM & BERNER, LLP, 1700 DIAGONAL ROAD, SUITE 300, ALEXANDRIA, VA, 22314, US

(73) Assignee: CHI MEI OPTOELECTRONICS CORP., Tainan County (TW)

(21) Appl. No.: 12/704,752

(22) Filed: Feb. 12, 2010

(30) Foreign Application Priority Data
Feb. 12, 2009 (TW) 98104553

(51) Int. Cl. G02F 1/1343; G02F 1/13357

(52) U.S. Cl. 349/65; 349/141

(57) ABSTRACT

A liquid crystal display (LCD) panel having a plurality of pixels includes a first substrate and a second substrate disposed opposite to each other. The first substrate has a common electrode layer which has a first common area and a second common area. The second substrate has a plurality of data lines, a plurality of scan lines, a plurality of signal lines and a pixel electrode layer. The data lines and the scan lines are disposed in array and around the pixels. The signal lines traverse the pixels, respectively. For each of the pixels, the pixel electrode layer overlaps the data line and/or the scan line, and is divided into a first pixel area and a second pixel area by the signal line. The first common area is disposed corresponding to the second pixel area. The first pixel area has a first slit pattern. At least one of the first common area and the second pixel area has a second slit pattern which differs from the first slit pattern in geometry.

### BACKGROUND OF THE INVENTION

1. Field of Invention

The invention relates to a display apparatus and the display panel thereof and, in particular, to a liquid crystal display apparatus and the liquid crystal display panel thereof.

2. Related Art

Liquid crystal display (LCD) apparatuses, having advantages such as low power consumption, less heat, light weight and non-radiation, are widely applied to various electronic products and gradually take the place of cathode ray tube (CRT) display apparatuses.

In general, the liquid crystal display apparatus mainly comprises an LCD panel and a backlight module. The LCD panel mainly has a thin film transistor (TFT) substrate, a color filter (CF) substrate and a liquid crystal layer sandwiched by the two substrates. In addition, a plurality of pixels are formed in matrix by the substrates and the liquid crystal layer. The backlight module makes the light emitted from a light source averagely spread to the LCD panel, and an image can be formed via the pixels displaying various colors. However, when people watch the LCD panel in different angles (such as in a front or a side angle), the voltage-transmittance curve of the pixel will change, thereby causing color shift effect on the LCD apparatuses.

To eliminate the color shift effect, some technologies have been developed. Most of them divide a single pixel into a dark region and a light region, and these two regions have different voltage-transmittance curves when people watch the LCD apparatus in a front angle or in a side angle. Accordingly, the low color shift (LCS) can be achieved through the compensation of the curves.

FIG. 1 shows the layout of a pixel P1 of the LCD panel using LCS technology. As shown in FIG. 1, the LCD panel has a TFT substrate and a CF substrate. The TFT substrate includes a plurality of scan lines SL_{N}, SL_{N+1}, a plurality of data lines DL_{M}, DL_{M+1}, a plurality of signal lines SC, a pixel electrode layer 11 and a plurality of TFTs T1˜T3. The scan lines SL_{N}, SL_{N+1} and the data lines DL_{M}, DL_{M+1} define the region of the pixels, and the pixel electrode layer 11 is disposed inside the pixels. Here, the pixel P1 is illustrated as an example. The pixel electrode layer 11 is disposed in the pixel P1, the TFTs T1, T2 are electrically connected with the scan line SL_{N}, and the TFT T3 is electrically connected to the next scan line SL_{N+1}. The signal line SC traverses the pixel P1, at a distance D from the scan line SL_{N+1}.

In the pixel P1, the pixel electrode layer 11 has a slit pattern g1 which includes a main slit g11 and a plurality of secondary slits g12. The main slit g11 divides the pixel electrode layer 11 into a light region 111 and a dark region 112 (the light region 111 surrounds the dark region 112) insulated with each other. The main slit g11 and the secondary slits g12 make the pixel P1 multi-domain alignment effect. When the scan line SL_{N} transfers the turn on signal, the TFTs T1, T2 drive the dark region 112 and the light region 111 (at this time, the light region 111 and the dark region 112 have the same brightness due to the same applied voltage). Then, when the next scan line SL_{N+1} turns on, the voltage applied to the pixel electrode layer of the dark region 112 is lowered due to the redistribution of charges caused by the turn on of the TFT T3, so that the brightness of the dark region 112 is less than that of the light region 111. In addition, the light region 111 and the dark region 112 have different voltage-transmittance curves when people watch the LCD apparatus in a front or a side angle. These two phenomenons result in the compensation effect to eliminate color shift.

The CF substrate has a light-shielding layer 21 (the region of which is denoted by the pattern of sands in FIG. 1) to shield the uncontrolled light emitting region and light leaking region for improving the image quality.

The scan lines SL_{N}, SL_{N+1} and the common electrode layer (not shown in FIG. 1) of the CF substrate will form a fringe field. When the signals of the scan line SL_{N}, SL_{N+1} change, the liquid crystal exists between the scan lines SL_{N} or SL_{N+1} and the pixel electrode layer 11 will be driven by two fringe fields (one is produced by the pixel electrode and the common electrode, and the other is produced by the scan lines SL_{N} or SL_{N+1} and the common electrode) and thus change its orientation so that the brightness may be changed. The same situation also occurs among the data lines DL_{M}, DL_{M+1} and the pixel electrode layer 11. Therefore, the light is leaked at two sides of the scan lines SL_{N}, SL_{N+1} and the data lines DL_{M}, DL_{M+1}.

To avoid the light leaking, the prior art makes the light-shielding layer 21 extend from two sides of the scan lines SL_{N}, SL_{N+1} and the data lines DL_{M}, DL_{M+1} to the pixel electrode layer 11 and even cover the signal line CS, so that the region (defined by the distance D) between the signal line SC and the scan line SL_{N+1} is incapable of displaying, and thus the aperture ratio of the pixels is decreased greatly.

### SUMMARY OF THE INVENTION

In view of the foregoing subject, an object of the invention is to provide a liquid crystal display apparatus and the liquid crystal display panel thereof that can eliminate the light leaking beside pixels and increase the aperture ratio to improve the image quality.

To achieve the above object, a liquid crystal display (LCD) panel having a plurality of pixels includes a first substrate and a second substrate disposed opposite to each other. The first substrate has a common electrode layer which has a first common area and a second common area. The second substrate has a plurality of data lines, a plurality of scan lines, a plurality of signal lines and a pixel electrode layer. The data lines and the scan lines are disposed in array and around the pixels. The signal lines traverse the pixels, respectively. For each of the pixels, the pixel electrode layer overlaps the data line and/or the scan line, and is divided into a first pixel area and a second pixel area by the signal line. The first common area is disposed corresponding to the second pixel area. The first pixel area has a first slit pattern. At least one of the first common area and the second pixel area has a second slit pattern which differs from the first slit pattern in geometry.

To achieve the above object, an LCD apparatus includes a backlight module and an LCD panel which is disposed at a side of the backlight module and has a plurality of pixels. The LCD panel includes a first substrate and a second substrate disposed opposite to each other. The first substrate has a common electrode layer which has a first common area and a second common area. The second substrate has a plurality of data lines, a plurality of scan lines, a plurality of signal lines and a pixel electrode layer. The data lines and the scan lines are disposed in array and around the pixels. The signal lines traverse the pixels, respectively. For each of the pixels, the pixel electrode layer overlaps the data line and/or the scan line, and is divided into a first pixel area and a second pixel area by the signal line. The first common area is disposed corresponding to the second pixel area. The first pixel area has a first slit pattern. At least one of the first common area and the second pixel area has a second slit pattern which differs from the first slit pattern in geometry.

As mentioned above, in the LCD apparatus and the LCD panel of the invention, the pixel electrode layer overlaps the data line and/or the scan line, which causes shielding effect on the fringe field and thus avoids light leaking. In addition, different slit patterns (which can be disposed at the pixel electrode layer or the common electrode layer respectively) in geometry are respectively disposed at two sides of the signal line that traverses the pixel, so that the regions from the signal line to the adjacent scan lines can be capable of displaying and also the liquid crystal can be fast oriented by the slit patterns, thereby increasing the aperture ratio of the pixels, accelerating the response of the liquid crystal, and improving the image quality.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram showing a single pixel of a conventional LCD panel;

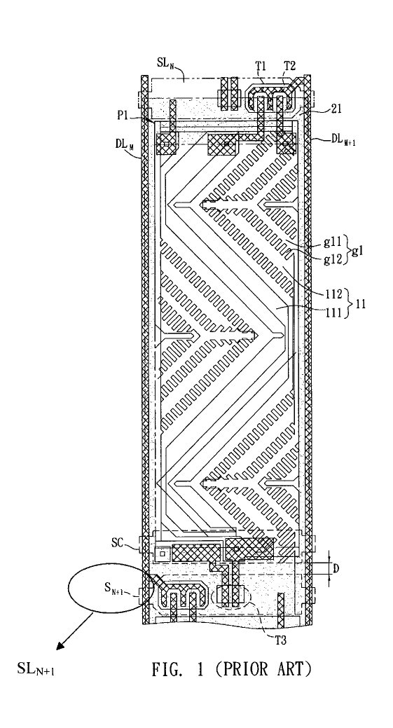

FIG. 2A is a schematic diagram showing an LCD panel according to a preferred embodiment of the invention;

FIG. 2B is a schematic diagram showing a common electrode layer and the common areas thereof in FIG. 2A;

FIG. 2C is a schematic diagram showing a pixel electrode layer and the pixel areas thereof in FIG. 2A;

FIG. 2D is a schematic diagram showing the layout of the circuit including thin film transistors in FIG. 2A;

FIGS. 3A and 3B are schematic diagrams showing various second slit pattern according to the preferred embodiment of the invention;

FIG. 4A is an enlarged view showing the pixel electrode layer overlapping the data line in FIG. 2A;

FIG. 4B is an enlarged view showing the pixel electrode layer overlapping the scan line in FIG. 2A; and

FIG. 5 is a schematic diagram showing an LCD apparatus according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

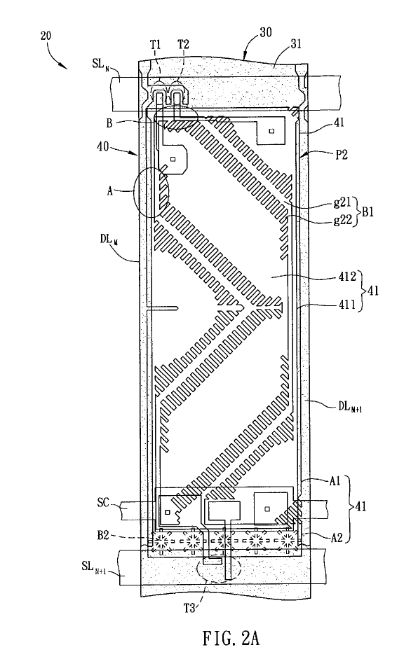

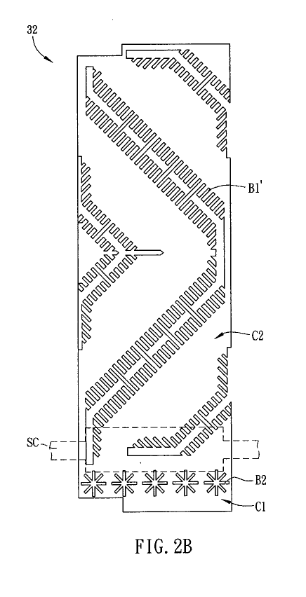

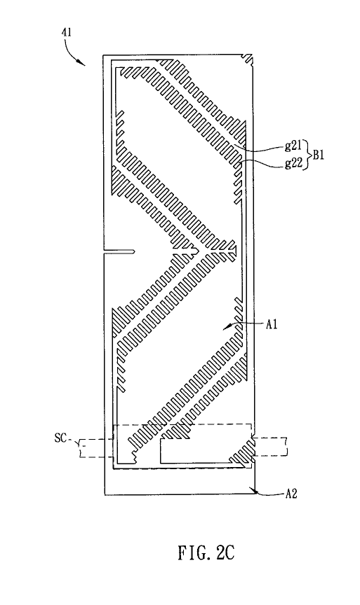

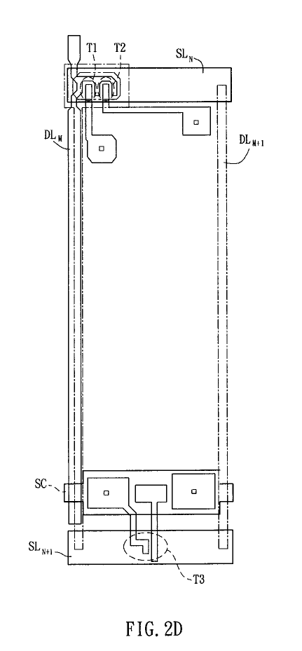

FIG. 2A is a schematic diagram showing a liquid crystal display (LCD) panel 20 according to a preferred embodiment of the invention, and FIGS. 2B to 2D are schematic views showing the main layers of the LCD panel 20. To be noted, for more clearly showing the features of the invention, some structures in FIG. 2B are omitted in FIG. 2A.

Referring to FIGS. 2A to 2D, the LCD panel 20 has a plurality of pixels which are disposed in matrix. FIG. 2A is a schematic view showing the layout of one of the pixels P2.

The LCD panel 20 includes a first substrate 30, a second substrate 40 and a liquid crystal layer (not shown in the figures) disposed between the first substrate 30 and the second substrate 40. In the embodiment, the first substrate 30 is a CF substrate which has a light-shielding layer 31 and a common electrode layer 32. The common electrode layer 32 (see FIG. 2B) is a transparent electrode layer. The light-shielding layer 31 (the region of which is denoted by the pattern of sands in FIG. 2A), disposed at the edge of the pixel P2, is a black matrix layer including chromium (Cr) or something else capable of anti-reflective, or a black resin layer, for example.

The second substrate 40, disposed opposite to the first substrate 30, is a TFT substrate in the embodiment, and has a plurality of scan lines SL_{N}, SL_{N+1}, a plurality of data lines DL_{M}, DL_{M+1}, a plurality of signal lines SC, and a pixel electrode layer 41 (see FIG. 2C). The scan lines SL_{N}, SL_{N+1} and the data lines DL_{M}, DL_{M+1} are disposed in array and around the pixel P2. The region of the pixel P2 is defined by the scan lines SL_{N}, SL_{N+1} and the data lines DL_{M}, DL_{M+1}, and all the pixels of the LCD panel 20 are defined by the all scan lines and all data lines.

In the embodiment, the pixel electrode layer 41 is, for example, an indium tin oxide (ITO) transparent layer, and overlaps the scan lines SL_{N}, SL_{N+1} and/or the data lines DL_{M}, DL_{M+1}. Here, the pixel electrode layer 41 overlaps the scan lines SL_{N}, SL_{N+1} and the data lines DL_{M}, DL_{M+1} to provide the shielding effect on the fringe field. To be noted, a thicker low permittivity composite material layer can be disposed between the pixel electrode layer 41 and the scan lines SL_{N}, SL_{N+1} and/or between the pixel electrode layer 41 and the data lines DL_{M}, DL_{M+1}, to decrease the coupling capacitance between the pixel electrode layer 41 and the scan lines SL_{N}, SL_{N+1} and/or between the pixel electrode layer 41 and the data lines DL_{M}, DL_{M+1}.

In the embodiment, the signal line SC is a common electrode line, traversing the pixel P2, and divides the pixel electrode layer 41 into a first pixel area A1 and a second pixel area A2 (see FIGS. 2A and 2C). Besides, the common electrode layer 32 is divided into a first common area C1 and a second common area C2 according to the signal line SC. Referring to FIGS. 2A to 2C, the first common area C1 is disposed corresponding to the second pixel area A2, and the second common area C2 is disposed corresponding to the first pixel area A1. As an example, the first pixel area A1 has a first slit pattern B1 and the first common area C1 has a second slit pattern B2 in the embodiment. To give clear contrast of that the first slit pattern B1 and the second slit pattern B2 differ from each other in geometry, FIG. 2A just shows the second slit pattern B2 of the first common area C1 plotted by a dotted line, but does not show the complete common electrode layer 32.

In the embodiment, the first slit pattern B1 and the second slit pattern B2 are different geometric categories and asymmetric. The geometric categories can be characters (such as Chinese or English characters) or symbols (such as mathematical or phonetic symbols). The first slit pattern B1 and the second slit pattern B2 can, for example, include a figure of “<”, “>”, “*”, “L”, or “Y”. Here, the first slit pattern B1 has a figure of “<” or “>”, and the second slit pattern B2 has a figure of “*”. To be noted, the second slit pattern B2 can be disposed to the second pixel area A2 instead of the first common area C1, or disposed to the second pixel area A2 and the first common area C1. Besides, the second common area C2 (see FIG. 2B) of the common electrode layer 32 is disposed corresponding to the first pixel area A1, and can be configured with the secondary slits (like the secondary slits g22 shown in FIG. 2C) or without the secondary slits. In the embodiment, the second common area C2 has a first slit pattern BF as an example.

In the invention, the first pixel area A1 can have a first slit pattern B1, and the first common area C1 and the second pixel area A2 can both have a second slit pattern B2 which differs from the first slit pattern B1 in geometry. Alternatively, the first pixel area A1 has a first slit pattern B1, and one of the first common area C1 and the second pixel area A2 has a second slit pattern B2 which differs from the first slit pattern B1 in geometry. Because the second pixel area A2 exists between the signal line SC and the scan line SL_{N+1}, the aperture ratio of the pixel is increased. Besides, due to the second slit pattern B2 of the first common area C1, when the LCD panel is driven, the liquid crystal corresponding to the first common area C1 can be fast oriented in a short time (about 10 ms) so as to accelerate the response of the liquid crystal and improve the image quality. On the contrary, if the first common area C1 does not have the second slit pattern B2, the liquid crystal corresponding to the second pixel area A2 can not oriented to the preset position after the LCD panel is driven for a long time (about 60 ms), so as to result in the slow response of the liquid crystal and decrease the image quality.

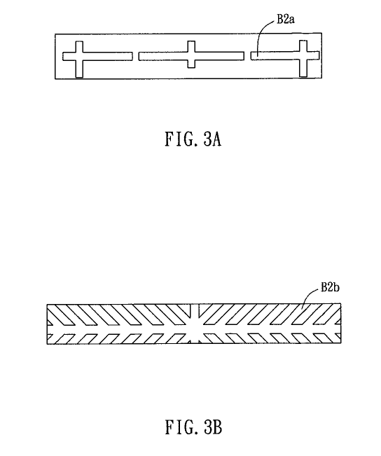

The second slit pattern B2 can be configured in various ways. As shown in FIGS. 3A and 3B, the second slit pattern B2a including a figure of “+” or “L”, can be disposed to the second pixel area A2 in FIG. 2C or the first common area C1 in FIG. 2B, and the first slit pattern B1 and the second slit pattern B2a still differ in geometry. Besides, as shown in FIG. 3B, the second slit pattern B2b of the second pixel area A2 or the first common area C1 can include a figure of “*”, “<” or “>”, and the first slit pattern B1 and the second slit pattern B2b still differ in geometry. In the embodiment, the pixel P2 is applied with the LCS technology, and the signal line SC is closer to the scan line SL_{N+1} than the scan line SL_{N}. Here, the first pixel area A1 is four times larger than the second pixel area A2, or the distance from the signal line SC to the scan line SL_{N} is four times larger than that from the signal line SC to the scan line SL_{N+1}. Besides, the pixel electrode layer 41 includes a first area 411 and a second area 412 insulated with each other. In the invention, the first area 411 and the second area 412 are not limited in shape or aspect. In the embodiment, the first slit pattern B1 has a main slit g21 and a plurality of secondary slits g22. The first area 411 and the second area 412 are divided and insulated with each other by the main slit g21. Besides, the first area 411 that is a light region surrounds the second area 412 that is a dark region. Each of the first area 411 and the second area 412 has secondary slits g22, and the secondary slits g22 are disposed opposite to each other. The secondary slits g22 make the pixel P2 multi-domain alignment effect.

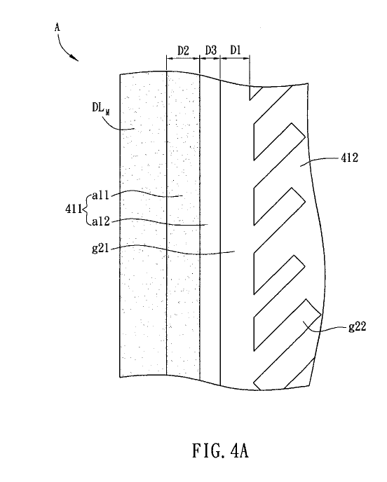

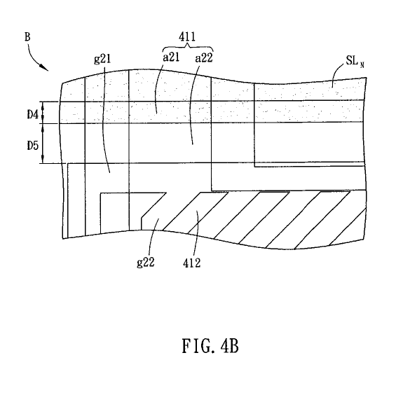

The second substrate 40 further has a plurality of TFTs T1˜T3. The TFTs T1, T2 are electrically connected with the scan line SL_{N}, and are electrically connected with the first area 411 and the second area 412 respectively. The TFT T3 is electrically connected with the next scan line SL_{N+1} and the second area 412. When the scan line SL_{N} turns on, the TFTs T1, T2 drive the first area 411 and the second area 412 (at this time, the first area 411 and the second area 412 have the same brightness). Then, when the next scan line SL_{N+1} turns on, the brightness of the second area 412 is less than that of the first area 411 by the turn on of the TFT T3 and the second area 412 becomes a dark region. In addition, the first area 411 and the second area 412 have different voltage-transmittance curves when people watch the LCD panel in a front or a side angle, and these two phenomenons result in the compensation effect for eliminating color shift. In addition to accelerating the response of the liquid crystal, the invention can further increase the aperture ratio of the pixel. Referring to FIG. 2A in conjunction with FIGS. 4A and 4B, in each pixel P2, the pixel electrode layer 41 is an ITO transparent layer and includes the first area 411 and the second area 412 insulated with each other. A case where the first area 411 is a light region and the second area 412 is a dark region will be explained as an illustrative example. Of course, the driving method can be changed so that the first area 411 is a dark region and the second area 412 is a light region.

The first area 411 overlaps the data line DL_{M}, DL_{M+1} and/or the scan line SL_{N}, SL_{N+1}. In the embodiment, the first area 411 overlaps the data line DL_{M}, DL_{M+1} and the scan line SL_{N}, SL_{N+1}. Preferably, the area of the first area 411 overlapping the data line DL_{M} is substantially equal to that of the first area 411 overlapping the data line DL_{M+1}, or the area of the first area 411 overlapping the scan line SL_{N} is substantially equal to that of the first area 411 overlapping the scan line SL₊₁. Accordingly, in each pixel, the capacitances formed by the first area 411 and the data line DL_{M}, DL_{N+1} can be the same, or the capacitances formed by the first area 411 and the scan line SL_{N}, SL_{N+1} can be the same, to simplify the controlling circuit.

The cases where the first area 411 overlaps the data line DL_{M} and the scan line SL_{N} are shown in FIGS. 4A and 4B. FIGS. 4A and 4B are enlarged views of the areas denoted by numerals A and B in FIG. 2A, respectively.

As shown in FIG. 4A, the first area 411 has a first portion all and a second portion a12 connecting with each other. The first portion all overlaps the data line DL_{M}, and the second portion a12 does not overlap the data line DL_{M}. Besides, the second portion a12 and the second area 412 are disposed at two sides of the main slit g21 respectively.

Because the main slit g21 is closer to the data line DL_{M}, the main slit g21 may overlap the data line DL_{M} or the first portion all may not overlap the data line DL_{M} due to the inaccuracy of photolithography process forming the pixel electrode layer 41, which leads the pixel electrode layer 41 not to overlap the data line DL_{M}. So, the shielding effect can not be generated at all on the fringe field, and the light leaking thus occurs. However, by the first portion all overlapping the data line DL_{M} and the second portion a12 not overlapping the data line DL_{M}, the invention can make the pixel electrode layer 41 overlap the data line DL_{M}, allowing a certain inaccuracy of photolithography process forming the pixel electrode layer 41 (for example, the pixel electrode layer 41 is shifted leftwards or rightwards), to provide the shielding effect.

In the embodiment, the main slit g21 has a width D1 not less than 2 p.m. The first portion all and the second portion a12 are parallel to the data line DL_{M}. The first portion all has a width D2 not less than 2 p.m, and the second portion a12 has a width D3 not less than 2 μm.

The principle applied to the arrangement of first portion all and the second portion a12 of the first area 411 can be also applied to the arrangement of first area 411 and the scan line SL_{N} as shown in FIG. 4B. The first area 411 has a first portion a21 and a second portion a22. The first portion a21 overlaps the scan line SL_{N} and the second portion a22 does not overlap the scan line SL_{N}.

Because the main slit g21 is closer to the scan line SL_{N}, the main slit g21 may overlap the scan line SL_{N} or the first portion a21 may not overlap the scan line SL_{N} due to the inaccuracy of photolithography process forming the pixel electrode layer 41, which leads the pixel electrode layer 41 not to overlap the scan line SL_{N}. So, the shielding effect can not be generated at all on the fringe field, and the light leaking thus occurs. However, by the first portion a21 overlapping the scan line SL_{N} and the second portion a22 not overlapping the scan line SL_{N}, the invention can make the pixel electrode layer 41 overlap the scan line SL_{N}, allowing a certain inaccuracy of photolithography process forming the pixel electrode layer 41 (for example, the pixel electrode layer 41 is shifted upwards or downwards), to provide the shielding effect.

In the embodiment, the first portion a21 and the second portion a22 are parallel to the scan line SL_{N}. The first portion a21 has a width D4 not less than 2 μm, and the second portion a22 has a width D5 not less than 2 μm.

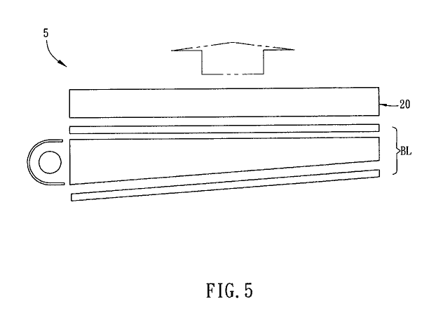

FIG. 5 is a schematic diagram showing an LCD apparatus 5 according to a preferred embodiment of the invention. The LCD apparatus 5 includes an LCD panel 20 and a backlight module BL. The LCD panel 20 is disposed at a side of the backlight module BL, and can include all the features of the LCD panel 20 as mentioned above, so a detailed description will be omitted herein. The backlight module BL can be a side-edge type backlight module or a direct type backlight module, and here the direct type backlight module is illustrated as the backlight module BL. The backlight module BL can include a light-guiding plate, a light source, a reflective cover, a reflective sheet and an optical film set.

In summary, in the LCD apparatus and the LCD panel of the invention, the pixel electrode layer overlaps the data line and/or the scan line, which causes shielding effect on the fringe field and thus avoids light leaking. In addition, different slit patterns (which can be disposed at the pixel electrode layer or the common electrode layer respectively) in geometry are respectively disposed at two sides of the signal line that traverses the pixel, so that the region from the signal line to the two scan lines can be capable of displaying and also the liquid crystal can be fast oriented by the slit patterns, thereby increasing the aperture ratio of the pixels, accelerating the response of the liquid crystal, and improving the image quality.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A liquid crystal display panel having a plurality of pixels, comprising:
a first substrate having a common electrode layer which has a first common area and a second common area; and
a second substrate disposed opposite to the first substrate and having a plurality of data lines, a plurality of scan lines, a plurality of signals and a pixel electrode layer, wherein the data lines and the scan lines are disposed around the pixels and in array, and the signal lines traverses the pixels respectively,
wherein for each of the pixels, the pixel electrode layer overlaps the data line and/or the scan line and is, by the signal line, divided into a first pixel area having a first slit pattern and a second pixel area disposed corresponding to the first common area of the common electrode layer, and at least one of the first common area and the second pixel area has a second slit pattern which differs from the first slit pattern in geometry.

2. The liquid crystal display panel as recited in claim 1, wherein the first slit pattern and the second slit pattern include a figure of “<”, “>”, “*”, “L”, or “Y”.

3. The liquid crystal display panel as recited in claim 1, wherein the first pixel area is four times larger the second pixel area.

4. The liquid crystal display panel as recited in claim 1, wherein the pixel electrode layer has a first area and a second area insulated with each other, and the first area overlaps the data line and/or the scan line.

5. The liquid crystal display panel as recited in claim 4, wherein the first area surrounds the second area.

6. The liquid crystal display panel as recited in claim 4, wherein the first area has a first portion and a second portion connecting with each other, the first portion overlaps the data line and/or the scan line, and the second portion does not overlap the data line and/or the scan line.

7. The liquid crystal display panel as recited in claim 6, wherein the first portion has a width not less than 2 μm

8. The liquid crystal display panel as recited in claim 6, wherein the second portion has a width not less than 2 μm.

9. The liquid crystal display panel as recited in claim 6, wherein the pixel electrode layer further has a main slit, and the second portion and the second area are disposed at two sides of the main slit respectively.

10. The liquid crystal display panel as recited in claim 9, wherein the main slit has a width not less than 2 μm.

11. A liquid crystal display apparatus, comprising:
a backlight module; and
a liquid crystal display panel disposed to one side of the backlight module and having a plurality of pixels, comprising:
a first substrate having a common electrode layer which has a first common area and a second common area, and
a second substrate disposed opposite to the first substrate and having a plurality of data lines, a plurality of scan lines, a plurality of signals and a pixel electrode layer, wherein the data lines and the scan lines are disposed in array and around the pixels, and the signal lines traverses the pixels respectively,
wherein for each of the pixels, the pixel electrode layer overlaps the data line and/or the scan line and is, by the signal line, divided into a first pixel area having a first slit pattern and a second pixel area disposed corresponding to the first common area of the common electrode layer, and at least one of the first common area and the second pixel area has a second slit pattern which differs from the first slit pattern in geometry.

12. The liquid crystal display apparatus as recited in claim 11, wherein the first slit pattern and the second slit pattern include a figure of “<”, “>”, “*”, “L”, or “Y”.

13. The liquid crystal display apparatus as recited in claim 11, wherein the first pixel area is four times larger the second pixel area.

14. The liquid crystal display apparatus as recited in claim 11, wherein the pixel electrode layer has a first area and a second area insulated with each other, and the first area overlaps the data line and/or the scan line.

15. The liquid crystal display apparatus as recited in claim 14, wherein the first area surrounds the second area.

16. The liquid crystal display apparatus as recited in claim 14, wherein the first area has a first portion and a second portion connecting with each other, the first portion overlaps the data line and/or the scan line, and the second portion does not overlap the data line and/or the scan line.

17. The liquid crystal display apparatus as recited in claim 16, wherein the first portion has a width not less than 2 μm.

18. The liquid crystal display apparatus as recited in claim 16, wherein the second portion has a width not less than 2 μm.

19. The liquid crystal display apparatus as recited in claim 16, wherein the pixel electrode layer further has a main slit, and the second portion and the second area are disposed at two sides of the main slit respectively.

20. The liquid crystal display apparatus as recited in claim 11, wherein the backlight module is a side-edge type backlight module or a direct type backlight module.
